(19) United States
(12) Patent Application Publication
(10) Pub. No.: US 2025/0257832 A1
(43) Pub. Date: Aug. 14, 2025

(54) COUPLING SYSTEM FOR ARTICULATING PIPE JOINT

(71) Applicant: Northwest Pipe Company, Vancouver, WA (US)

(72) Inventor: Brent D. Keil, Salt Lake City, UT (US)

(73) Assignee: Northwest Pipe Company, Vancouver, WA (US)

(21) Appl. No.: 19/193,572

(22) Filed: Apr. 29, 2025

Related U.S. Application Data
(63) Continuation of application No. PCT/US2023/078717, filed on Nov. 3, 2023.
(60) Provisional application No. 63/423,386, filed on Nov. 7, 2022.

(51) Int. Cl. F16L 37/091; F16L 1/036; F16L 37/50

(52) U.S. Cl. CPC F16L 37/091; F16L 1/036; F16L 37/50

(57) ABSTRACT

Coupling systems for pipes that are press fit together in trenchless tunneling operations and which provide for the construction of curved pipelines can include a pipe with a pipe axis, a first end portion and a second end portion. The second end portion includes a female coupler having an inner wall surface and a set of coupler features formed on the inner wall surface, the coupler features including a plurality of teeth and a plurality of ramp surfaces between the teeth. The second end portion of the pipe includes a radially-extending distal end surface. The female coupler further includes a radially-extending shelf formed in the inner wall surface on an opposite side of the coupler features from the distal end surface. The distal end surface and the shelf are angled relative to a radially-extending reference line that is perpendicular to the pipe axis.

### CROSS REFERENCE TO RELATED APPLICATIONS

This application is a continuation of International Application No. PCT/US2023/078717, filed Nov. 3, 2023, which claims the benefit of U.S. Provisional Application No. 63/423,386, filed Nov. 7, 2022. Each of the above applications is incorporated herein by reference in its entirety.

### FIELD

The present disclosure relates to coupling systems for pipes that are press fit together in tunneling operations and that facilitate the construction of curved pipelines.

### BACKGROUND

Tunneling and microtunneling are trenchless tunnel construction techniques in which a shaft or tunnel is bored and sections of pipe are inserted into the shaft as boring progresses. Tunnel boring machines may have an operator onboard as the machine cuts through the ground. In microtunneling the diameter of the shaft may be too small to permit a human operator to ride along on the machine, and the machine may instead be controlled remotely from outside the shaft. The pipe sections placed in the tunnel form a protective casing for the tunnel, which can then accommodate other conduits, such as for utilities including water, sewer, electrical lines, fiber optic cables, etc. Tunneling and microtunneling can be advantageous when it is desirable to minimize ground subsidence and/or upheaval, such as when tunneling beneath buildings, roads, railroad tracks, etc. However, the pipes traditionally used in tunneling applications can curve only slightly, if at all, making the construction of curved tunnels difficult or impossible. Accordingly, there exists a need for improved coupling systems for pipes in tunneling applications.

### SUMMARY

Certain examples of the present disclosure pertain to coupling systems for pipes that are press fit together in trenchless tunneling operations and which provide for the construction of curved pipelines. In a representative example, a pipe comprises a pipe axis; a first end portion and a second end portion, the second end portion comprising a female coupler, the female coupler comprising an inner wall surface and a set of coupler features formed on the inner wall surface, the coupler features comprising a plurality of teeth and a plurality of ramp surfaces between the teeth, the first end portion of the pipe defining a pipe opening; the second end portion of the pipe comprising a radially-extending distal end surface; the female coupler further comprising a radially-extending shelf formed in the inner wall surface on an opposite side of the coupler features from the distal end surface; wherein the distal end surface and the shelf are angled relative to a radially-extending reference line that is perpendicular to the pipe axis.

In another representative example, a pipe comprises a pipe axis; a first end portion and a second end portion, the first end portion comprising a male coupler, the male coupler comprising an outer wall surface and a set of coupler features formed on the outer wall surface, the coupler features comprising a plurality of ramp surfaces and teeth, the first end portion of the pipe defining a pipe opening; the first end portion of the pipe comprising a radially-extending distal end surface; the male coupler further comprising a radially-extending shelf formed in the outer wall surface on an opposite side of the coupler features from the distal end surface; wherein the distal end surface and the shelf are angled relative to a radially-extending reference line that is perpendicular to the pipe axis.

In another representative example, a pipe system comprises a first pipe, comprising: a first pipe axis; a first end portion and a second end portion, the second end portion comprising a female coupler, the female coupler comprising an inner wall surface and a set of first coupler features formed on the inner wall surface, the first coupler features comprising a plurality of teeth and a plurality of ramp surfaces between the teeth, the first end portion of the first pipe defining a first pipe opening; the second end portion of the first pipe comprising a radially-extending distal end surface; the female coupler further comprising a radially-extending shelf formed in the inner wall surface on an opposite side of the first coupler features from the distal end surface; wherein the distal end surface and the shelf are angled relative to a radially-extending reference line that is perpendicular to the first pipe axis; and a second pipe comprises a second pipe axis; a first end portion and a second end portion, the first end portion comprising a male coupler, the male coupler comprising an outer wall surface and a set of coupler features formed on the outer wall surface, the coupler features comprising a plurality of ramp surfaces and teeth, the first end portion of the second pipe defining a pipe opening; the first end portion of the second pipe comprising a radially-extending distal end surface; the male coupler further comprising a radially-extending shelf formed in the outer wall surface on an opposite side of the coupler features from the distal end surface; wherein the distal end surface and the shelf of the male coupler are angled relative to a radially-extending reference line that is perpendicular to the second pipe axis; wherein the male coupler of the second pipe is received within the female coupler of the first pipe such that the male coupler features engage the female coupler features to form a pipe joint.

In another representative example, a pipe comprises a first end portion comprising a female coupler, the female coupler comprising an inner wall surface and a set of coupler features formed on the inner wall surface, the first end portion of the pipe defining a pipe opening; the pipe comprising a radially-extending shelf formed in the inner wall surface on an opposite side of the coupler features from the pipe opening; wherein the coupler features comprise a repeating unit of, in a direction toward the pipe opening, a radially-extending tooth surface and a ramp surface that extends from the tooth surface to an annular surface, wherein a next radially-extending tooth surface extends from the annular surface.

In another representative example, a pipe comprises a pipe axis; a female coupler mounted to or formed in a first end of the pipe, the female coupler comprising an inner wall surface and a set of coupler features formed on the inner wall surface, the coupler features comprising a plurality of ramp surfaces and teeth, the first end of the pipe defining a pipe opening; the first end of the pipe comprising a distal end and a radially-extending shelf formed in the inner wall surface on an opposite side of the coupler features from the distal end; the coupler features comprising, in a direction from the shelf toward the distal end, a first annular surface having a first annular surface diameter that is constant moving in the direction toward the distal end, a first ramp surface with a first ramp surface diameter that increases in the direction toward the distal end, a second annular surface having a second annular surface diameter that is constant moving in the direction toward the distal end, a first tooth comprising a first tooth surface extending radially from the second annular surface toward the pipe axis, and a second ramp surface extending from the first tooth surface to a third annular surface in the direction toward the distal end.

In another representative example, a pipe system comprises a first pipe comprising a female coupler having a distal end and a radially-extending shelf formed in an inner wall surface of the first pipe, the shelf being spaced apart from the distal end along a longitudinal axis of the first pipe; a second pipe comprising a male coupler received in the female coupler of the first pipe to form a joint; the female coupler of the first pipe comprising a plurality of tooth surfaces extending radially inwardly from annular surfaces formed in the inner wall surface of the first pipe; the male coupler of the second pipe comprising a plurality of radially-extending tooth surfaces formed in an outer wall surface of the second pipe, the tooth surfaces of the second pipe engaging the tooth surfaces of the first pipe, wherein the annular surfaces of the second pipe are axially aligned with annular surfaces of the first pipe, and wherein gaps measured in the radial direction between the annular surfaces of the second pipe and the axially aligned annular surfaces of the first pipe increase moving in a direction from the distal end of the first pipe toward the shelf of the first pipe.

In another representative example, a pipe system comprises a first pipe comprising a female coupler having a distal end and a radially-extending shelf formed in an inner wall surface of the first pipe, the shelf being spaced apart from the distal end along a longitudinal axis of the first pipe; a second pipe comprising a male coupler received in the female coupler of the first pipe to form a joint; the female coupler of the first pipe comprising a plurality of tooth surfaces extending radially inwardly from annular surfaces formed in the inner wall surface of the first pipe; the male coupler of the second pipe comprising a plurality of radially-extending tooth surfaces formed in an outer wall surface of the second pipe, the tooth surfaces of the second pipe engaging the tooth surfaces of the first pipe, wherein radial heights of the tooth surfaces of the first pipe are greater than radial heights of the tooth surfaces of the second pipe.

In another representative example, a pipe system comprising: a first pipe comprising a female coupler having a distal end and a radially-extending shelf formed in an inner wall surface of the first pipe, the shelf being spaced apart from the distal end along a longitudinal axis of the first pipe; a second pipe comprising a male coupler received in the female coupler of the first pipe to form a joint; the female coupler of the first pipe comprising a plurality of tooth surfaces extending radially inwardly from annular surfaces formed in the inner wall surface of the first pipe; the male coupler of the second pipe comprising a plurality of radially-extending tooth surfaces formed in an outer wall surface of the second pipe, the tooth surfaces of the second pipe engaging the tooth surfaces of the first pipe, wherein the male coupler comprises a first annular surface nearest an opening defined by the second pipe, the female coupler comprises a first annular surface nearest the shelf of the female coupler, and wherein a gap defined between the first annular surface of the male coupler and the first annular surface of the female coupler is 70% to 110% of a radial height of the tooth surfaces of the female coupler.

### BRIEF DESCRIPTION OF THE DRAWINGS

FIGS. 1 and 2 are schematic side elevation views of an exemplary microtunneling project.

FIG. 3 is a perspective view of an example of a pipe system with two pipes coupled together at a joint and angulated relative to each other.

FIG. 4 is a cross-sectional side elevation view through the joint between the pipes in FIG. 3.

FIG. 5 is a partial cross-sectional view of an example of a female coupler.

FIG. 6 is a magnified cross-sectional view of a proximal portion of the female coupler of FIG. 5.

FIG. 7 is a magnified cross-sectional view of a distal portion of the female coupler of FIG. 5.

FIG. 8 is a partial cross-sectional view of an example of a male coupler.

FIG. 9 is a magnified cross-sectional view of a proximal portion of the male coupler of FIG. 8.

FIG. 10 is a magnified cross-sectional view of a distal portion of the male coupler of FIG. 8.

FIGS. 11 and 12 are schematic representations of the female coupler of FIG. 5 and the male coupler of FIG. 8 as cones.

### DETAILED DESCRIPTION

### Explanation of Terms

The following explanations of terms are provided to assist in understanding the present disclosure. For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed examples can be used in conjunction with other examples.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better or otherwise preferable to other selections.

In the description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing quantities of components, forces, moments, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing embodiments from discussed prior art, the embodiment numbers are not approximates unless the word “about” is recited.

Although there may be alternatives for various components, parameters, ratios, dimensions, operating conditions, etc., set forth herein, that does not mean that those alternatives are necessarily equivalent and/or perform equally well. Nor does it mean that the alternatives are listed in a preferred order unless stated otherwise.

Where applicable, values and relationships modified by the term “substantially” mean±10% of the stated value or relationship. The term “substantially parallel” means an angle of +10° between an object and a reference. The term “substantially perpendicular” means an angle of 80° to 100° between an object and a reference.

### Overview of the Disclosed Technology

The present disclosure pertains to coupling systems for pipes that are press fit together, such as in tunneling applications, which permit articulation of the coupled pipes within a selected range of motion. The coupling systems can comprise male and female couplings including a plurality of coupler features that engage when the male coupling is inserted into the female coupling. The coupling features of the female coupler can be formed in an inner wall surface of the female coupling, and can include a plurality of teeth and a plurality of ramp surfaces between the teeth. The distal end portion of the female coupling can have a radially-extending distal end surface. The female coupling can further comprise a radially-extending shelf formed in the inner wall surface on the opposite side of the coupler features from the distal end surface. The distal end surface and the shelf can be angled relative to a radially-extending reference line that is perpendicular to the pipe axis.

The male coupling can comprise a plurality of coupling features formed in an outer wall surface of the male coupling. The coupling features of the male coupling can also include a plurality of teeth and a plurality of ramp surfaces between the teeth. The male coupling can also comprise a distal end surface and a shelf on the opposite side of the coupling features from the distal end surface. The distal end surface and the shelf of the male coupling can also be angled relative to a radially-extending reference line that is perpendicular to the pipe axis. In certain examples, the teeth of the male coupling can decrease in height or “step down” in a direction toward the male coupler pipe opening at a higher rate than the teeth of the female coupling “step up” in the direction toward the female coupler pipe opening. As a result, there can be a gap between the male coupling features and the female coupling features when the couplers are engaged. The gap can increase in a direction toward the proximal shelf of the female coupling. The gap between the features can permit the male coupling to articulate relative to the female coupling within a selected range of motion. The angled distal end surfaces and angled shelf surfaces of the male and female couplings can also facilitate contact between these surfaces when the pipe couplings are angled, permitting transmission of jacking force along sequential pipes of a pipe system in a curved tunnel.

### Example 1: Tunnel Boring and Microtunneling

Tunnels are typically bored under roads, buildings, and other structures in order to install utility conduits while minimizing ground subsidence and disturbance. Such tunnels typically have a tunnel casing comprising a string of pipes that are coupled together end to end and inserted into the tunnel as boring progresses. Typical pipe diameters range from 36 inches to 96 inches or greater. When the inner diameter of the tunnel is too small to permit an operator to ride along on the tunnel boring machine, such operations are typically referred to as “microtunneling” operations.

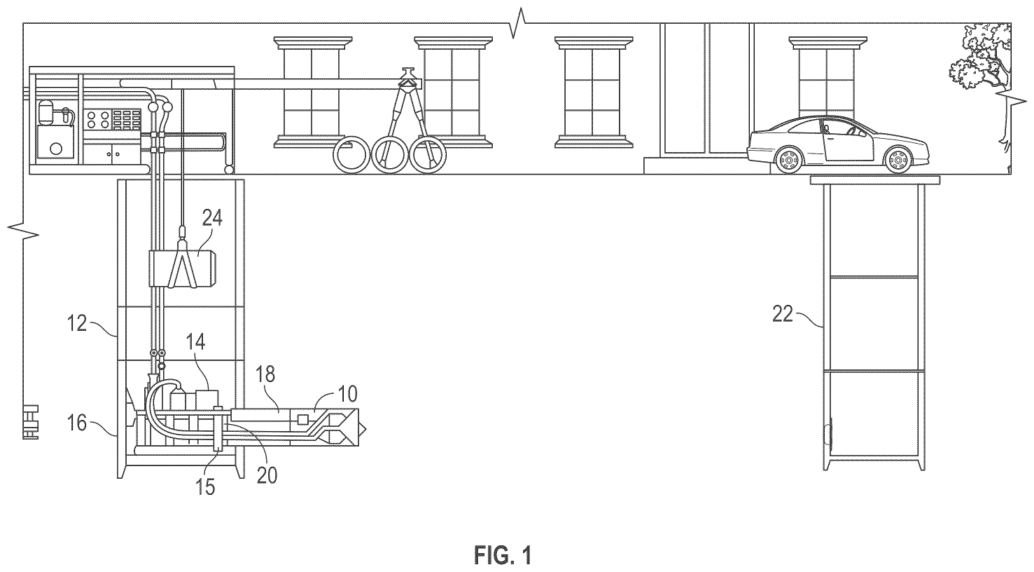

With reference to FIG. 1, in microtunneling, a microtunneling machine 10 (also referred to as a pipe-jacking machine) is placed in a pit or shaft referred to as a “launch shaft” or a “drive shaft” 12. The microtunneling machine 10 can have a cutting head selected for tunneling through the material (e.g., soil, clay, rock, etc.) along a selected path between the launch shaft 12 and a reception shaft 22. A hydraulic jacking rig 14 is positioned in the launch shaft 12 between a reaction wall 16 and the microtunneling machine 10. The jacking rig 14 can have one or a plurality of hydraulic jacks 15. In certain examples, the jacking rig 14 can be on a track or other support and/or guide positioned in the launch shaft. A first pipe 18 (also referred to as a first casing pipe) having a specified length and diameter is attached to the microtunneling machine 10. The jacking rig 14 can engage the first pipe 18 with a coupling ring 20. The jacking rig 14 can thrust the first pipe 18 and the microtunneling machine 10 forward through the ground along a predetermined trajectory toward the reception shaft 22. The microtunneling machine 10 can bore a tunnel of specified diameter as it is pushed through the ground.

After the microtunneling machine 10 has traveled a specified distance, the hydraulic jacks 15 of the jacking rig 14 can be retracted. The specified distance can be such that a trailing end of the first pipe 18 is accessible in the launch shaft 12, and there is sufficient space between the jacking rig 14 and the first pipe 18 to lower a second pipe 24 into the launch shaft 12. The second pipe 24 can have coupling features on its leading end that engage coupling features on the trailing end of the first pipe 18. In certain examples, the trailing end of the first pipe 18 can comprise a male coupler comprising a plurality of teeth configured to engage teeth of a female coupler of the leading end of the second pipe as further described below.

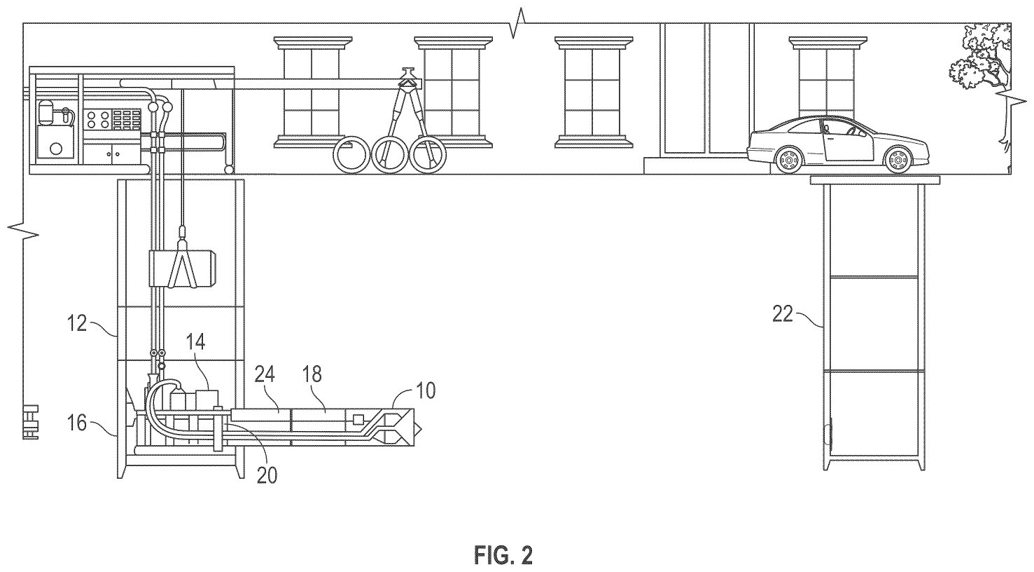

Referring to FIG. 2, after the second pipe 24 is placed in the launch shaft the jacking rig 14 can engage the second pipe 24 with the coupling ring 20. The second pipe 24 can be coupled to the first pipe 18 by driving the female coupler of the second pipe 24 over the male coupler of the first pipe 18 with the jacking rig 14. The jacking rig 14 can then be used to push the second pipe 24, the first pipe 18, and the microtunneling machine 10 forward toward the reception shaft 22. Additional pipes can be inserted and coupled to the pipe string in the manner above until the microtunneling machine 10 reaches the reception shaft 22. The microtunneling machine 10 can then be removed, and the string of coupled pipes can be left in place as a tunnel casing. The launch and reception shafts can then be finished as access shafts for servicing the tunnel and the utility conduits transiting the tunnel.

Tunnel boring for larger diameter tunnels can proceed in a similar manner as described above, except that an operator may ride along on the tunneling machine in the shaft to control the tunneling machine.

### Example 2: Coupling System for Articulating Pipe Joint

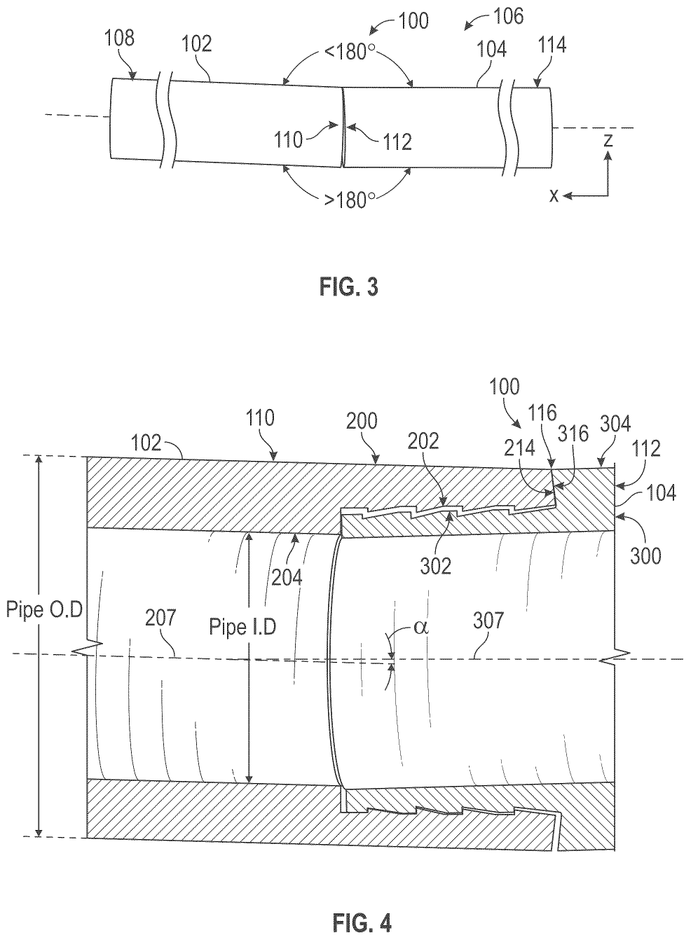

Certain examples of the disclosure pertain to coupling systems for pipes that are press fit together, and which permit the two coupled pipes to articulate within a specified range about the coupling. For example, FIG. 3 illustrates two pipes 102 and 104 coupled together at a joint 100 to form a pipe system 106 (also referred to as a pipeline or a pipe string). The first pipe 102 has a first end portion 108 and a second end portion 110. The second pipe 104 has a first end portion 112 and a second end portion 114. The first end portion 112 of the second pipe 104 is coupled to the second end portion 110 of the first pipe 102 at the joint 100.

The pipe axis of the first pipe 102 is angled relative to the pipe axis of the second pipe 104 such that the pipe system 106 is curved at the joint 100. For purposes of illustration the pipes 102 and 104 are angled in the x-z plane such that an angle measured on the inside of the curve at the vertex is less than 180° and an angle measured on the outside of the curve at the vertex (e.g., on the opposite side of the pipe joint) is greater than 180°. This results in a relatively small curve or deviation in the axis of the pipe system 106. By joining a plurality of pipes in this manner, it is possible to create a pipe system that defines a curved (e.g., non-straight) path between two end points, where the curvature is achieved in increments at each pipe joint.

FIG. 4 illustrates a cross section through the joint 100 of FIG. 3. In FIG. 4 the second end portion 110 of the pipe 102 has a female coupler 200 comprising a plurality of coupling features generally indicated at 202 that are formed in an inner wall surface 204 of the female coupler. The first end portion 112 of the second pipe 104 has a male coupler 300 including a plurality of coupling features generally indicated at 302 that are formed in an outer wall surface 304 of the male coupler.

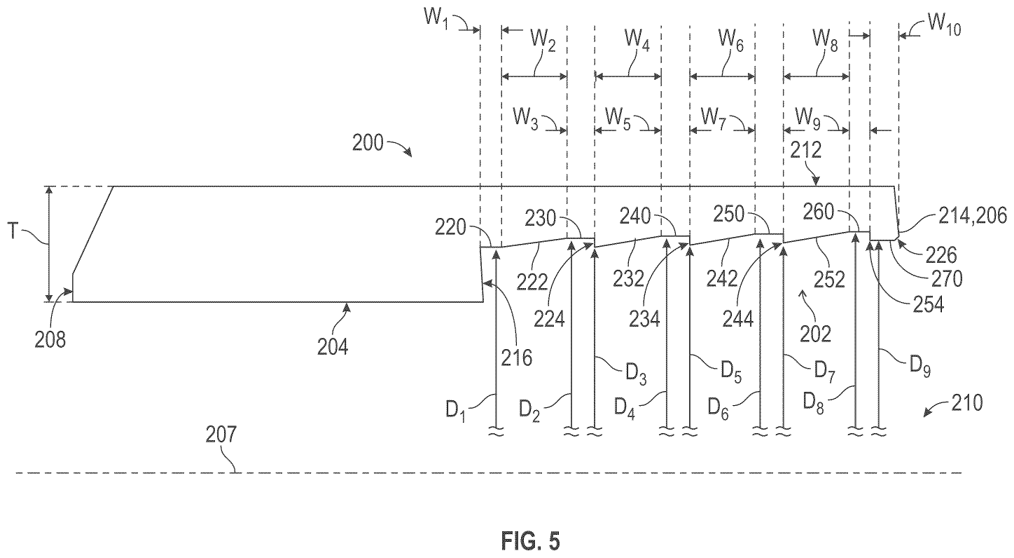

FIG. 5 illustrates a representative example of the female coupler 200 in greater detail. As noted with reference to FIG. 4 above, the female coupler 200 can comprise a plurality of coupling features generally indicated at 202 that are formed in an inner wall surface 204 of the coupler. In certain examples such as that shown in FIG. 5, the female coupler 200 can be a ring configured for mounting to the end of a main length of pipe, such as the pipes 102 and 104. Thus, in the illustrated example the female coupler 200 can have a first end 206 (also referred to as a distal end) and a second end 208 (also referred to as a proximal end). The second end 208 can be configured for attachment to the main length of pipe (e.g., by welding). Once attached to the pipe, the distal end 206 can define a pipe opening 210.

The coupling features 202 can comprise a variety of teeth and/or ridges, sloped and/or ramped surfaces, and/or surfaces that have a constant or substantially constant diameter. The coupling features 202 can be formed in a distal end portion 212 of the female coupler. At the distal end 206 the female coupler can comprise an end surface 214 (also referred to as a distal end surface). The end surface 214 can extend radially relative to the longitudinal pipe axis 207. Offset inwardly from the distal end 206 (to the left in FIG. 5) the female coupler can comprise a radially-extending surface referred to hereinafter as a “shelf” or a “proximal shelf” 216. From the shelf 216 onward in the proximal direction (e.g., toward the second end 208) the female coupler can have a first thickness T corresponding a nominal thickness of the pipe to which the female coupler is attached. From the shelf 216 moving in a distal direction the female coupler can have a reduced thickness in the area where the coupling features are machined into the inner wall surface 204.

Starting from the shelf 216 and moving in a direction toward the distal end surface 214 (e.g., in a direction toward the pipe opening), the coupler features of the female coupler can comprise a plurality of circumferentially-extending rings and/or surfaces 220, 230, 240, 250, 260, and 270 that have a constant or substantially constant diameter, referred to hereinafter as “annular surfaces.” The coupler features can also include a plurality of ramp surfaces 222, 232, 242, 252. The ramp surfaces 222, 232, 242, and 252 can be sloped in the direction of the pipe opening. The slopes can be such that the diameters of the ramp surfaces increase from left to right in FIG. 5 (e.g., in a direction toward the pipe opening).

The coupler features can also include a plurality of teeth generally indicated at 224, 234, 244, and 254. Each tooth can comprise a radially-extending surface that is perpendicular or substantially perpendicular to the pipe axis 207. Each tooth can also comprise an apex. In the illustrated example, the apices of the teeth can mark the transition from the radially-extending surface of the tooth to the adjacent ramp surface.

Thus, still referring to FIG. 5, the female coupler can comprise, in a direction from the shelf 216 toward the distal end surface 214, a first annular surface 220, a first ramp surface 222, a second annular surface 230, a first tooth 224, a second ramp surface 232, a third annular surface 240, a second tooth 234, a third ramp surface 242, a fourth annular surface 250, a third tooth 244, a fourth ramp surface 252, a fifth annular surface 260, a fourth tooth 254, and a sixth annular surface 270. In certain examples, a chamfer 226 can extend between the sixth annular surface 270 and the distal end surface 214.

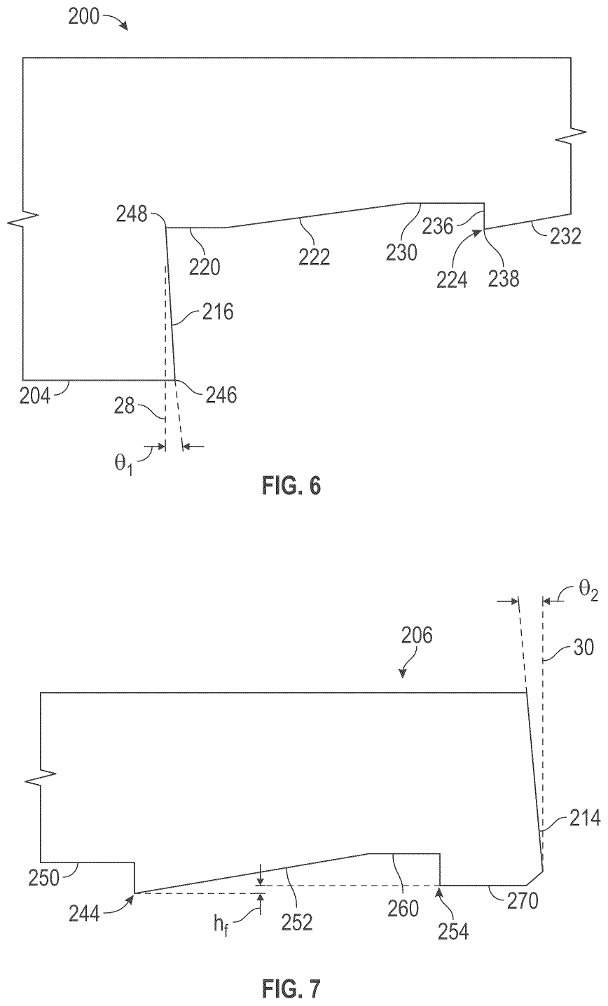

As noted above, each tooth can comprise a radially-extending surface and an apex. FIG. 6 illustrates the first tooth 224 by way of example. The first tooth 224 can include a radially-extending tooth surface 236 that is perpendicular or substantially perpendicular to the pipe axis 207, and an apex 238. The apex 238 can mark the transition between the radially-extending tooth surface 236 and the second ramp surface 232. In the illustrated example, the first tooth 224 does not include an annular surface between the apex 238 and the second ramp surface 232. This can facilitate angulation of the male coupler once received in the female coupler as further described below.

In certain examples, the distal end surface 214 and/or the shelf 216 can be angled relative to the pipe axis 207. In certain examples, the distal end surface 214 and/or the shelf 216 can be non-perpendicular with the pipe axis 207. In certain examples, one or both of the distal end surface 214 and the shelf 216 can be angled relative to a radially-extending reference line that is perpendicular to the pipe axis 207. For example, FIG. 6 illustrates the shelf 216 in greater detail. The radially-extending surface of the shelf 216 can define an angle θ₁ with a radially-extending reference line 28 that is perpendicular to the pipe axis. In certain examples, the angle θ₁ can be 1° to 45°, such as 1° to 30°, 1° to 20°, 1° to 10°, 2° to 45°, 2° to 30°, 2° to 20°, 2° to 10°, 5° to 20°, 5° to 15°, 5° to 10°, etc. In one particular example, the angle θ₁ can be 10°. In certain examples, the shelf 216 can be angled such that an apex 246 formed by the intersection of the radially-extending surface of the shelf 216 and the inner wall surface 204 of the coupler is closer to the first tooth 224 than an apex or corner 248 formed by the intersection of the first annular surface 220 and the radially-extending surface of the shelf 216. Stated differently, the apex 246 is closer to the pipe opening than the corner 248.

FIG. 7 illustrates the distal end surface 214 in greater detail. The radially-extending distal end surface 214 can define an angle θ₂ with a radially-extending reference line 30 that is perpendicular to the pipe axis 207. In certain examples, the angle θ₂ can be 1° to 45°, such as 1° to 30°, 1° to 20°, 1° to 10°, 2° to 45°, 2° to 30°, 2° to 20°, 2° to 10°, 5° to 20°, 5° to 15°, 5° to 10°, etc. In one particular example, the angle θ₂ can be 10°.

In certain examples, the angle θ₁ can be greater than the angle θ₂ or vice versa. In certain examples, the angles θ₁ and 02 can be equal.

In certain examples, the annular surfaces, ramps, and teeth of the coupler features can be arranged in repeating units along the inner wall surface. For example, referring again to FIG. 5, in the illustrated example the region of each tooth 224, 234, 244, and 254 can comprise a repeating unit of a radially-extending tooth surface, a ramp surface, and an annular surface. One such repeating unit is illustrated in detail in FIGS. 5 and 6. The repeating unit can comprise the radially-extending tooth surface 236 (FIG. 6) of the tooth 224, the ramp surface 232, and the annular surface 240 (FIG. 5). Moving in a direction toward the pipe opening, the annular surface 240 can lead directly to the next repeating unit, which is a second repeating unit comprising the radially-extending tooth surface of the tooth 234, the ramp surface 242, and the annular surface 250. In the illustrated example, the female coupler can comprise a third repeating unit including the radially-extending tooth surface 244, the ramp surface 252, and the annular surface 260. The illustrated female coupler can thus comprise three repeating units of coupler features as defined above in which each annular surface leads directly to the next radially-extending tooth surface, and each radially-extending tooth surface leads directly to the next ramp surface. Stated differently, the radially-extending surface of each tooth transitions immediately to the following ramp surface at the apex of the tooth without an annular surface between the radially-extending surface and the ramp surface. It should be understood that the female couplers described herein can have any number of repeating units of coupling features according to, for example, the specifications of a particular pipe system to be constructed.

Referring again to FIG. 5, the various coupler features can have widths measured along the pipe axis 207. For example, the first annular surface 220 can have a width W₁, the first ramp 222 can have a width W₂, the second annular surface 230 can have a width W₃, the second ramp surface 232 can have a width W₄, the third annular surface 240 can have a width W₅, the third ramp surface 242 can have a width W₆, the fourth annular surface 250 can have a width W₇, the fourth ramp surface 252 can have a width W₈, the fifth annular surface 260 can have a width W₉, and the sixth annular surface 270 can have a width W₁₀.

In certain examples, at least the widths W₃, W₅, W₇, and W₉ of the second, third, fourth, and fifth annular surfaces 230, 240, 250, and 260 can be equal or substantially equal (e.g., within +10% of the specified dimension). In certain examples, the width W₁ of the annular surface 220 can be greater than the widths W₃, W₅, W₇, and W₉ (e.g., to facilitate receiving the corresponding annular surface 360 at the distal end of the male coupler). The width W₁₀ of the annular surface 270 can also be greater than the widths W₃, W₅, W₇, and W₉. In certain examples, the width W₁₀ of the annular surface 270 can be greater than the width W₁ of the annular surface 220.

In certain examples, the widths W₂, W₄, W₆, and W₈ of the first, second, third, and fourth ramp surfaces 222, 232, 242, and 252 can be equal or substantially equal (e.g., within ±10% of the specified dimension). In certain examples, certain of the ramp surfaces can also be longer or shorter than the other ramp surfaces depending on the particular characteristics sought. In certain examples, the ramp surfaces can have the same slope. In other examples, certain of the ramps can have a different slope than other ramps. For example, in certain examples the ramp surface 252 can have a slope that is less than the slopes of the ramp surfaces 242, 232, and/or 222 to facilitate insertion of the male coupler 300 into the female coupler 200. Pipe couplers with ramp surfaces having different slopes are described in U.S. Pat. No. 10,823,320, which is incorporated herein by reference in its entirety.

Certain of the coupler features can also have diameters/radii measured perpendicular to the pipe axis 207. For example, the first annular surface 220 can have a diameter D₁, the second annular surface 230 can have a diameter D₂, the first tooth 224 can have a diameter D₃ (e.g., measured between two diametrically opposed locations on the apex of the first tooth 224), the third annular surface 240 can have a diameter D₄, the second tooth 234 can have a diameter D₅, the fourth annular surface 250 can have a diameter D₆, the third tooth 244 can have a diameter D₇, the fifth annular surface 260 can have a diameter D₈, and the sixth annular surface 270 can have a diameter D₉. The tooth 254 can have the same diameter Do as the sixth annular surface 270. The diameter of the first ramp surface 222 can increase from the diameter D₁ to the diameter D₂. The diameter of the second ramp surface 232 can increase from the diameter D₃ to the diameter D₄. The diameter of the third ramp surface 242 can increase from the diameter D₅ to the diameter D₆, and the diameter of the fourth ramp surface 252 can increase from the diameter D₇ to the diameter D₈.

Thus, in certain examples the female coupler can comprise coupler features including, from the shelf 216 in a direction toward the distal end 206, the first annular surface 220 having the diameter D₁ (the first annular surface diameter) that is constant moving in the direction toward the distal end, the first ramp surface 222 with a diameter (a first ramp surface diameter) that increases in the direction toward the distal end, the second annular surface 230 having the diameter D₂ (the second annular surface diameter) that is constant moving in the direction toward the distal end, the first tooth 224 comprising the first tooth surface 236 extending radially from the second annular surface 230 toward the pipe axis 207, and the second ramp surface 232 extending from the first tooth surface 236 to the third annular surface 240 in the direction of the distal end. In this example, the first tooth 224 does not have a flat annular surface extending from its apex 238 but instead transitions immediately to the ramp surface 232. This facilitates angulation of the male coupler relative to the female coupler as further explained below.

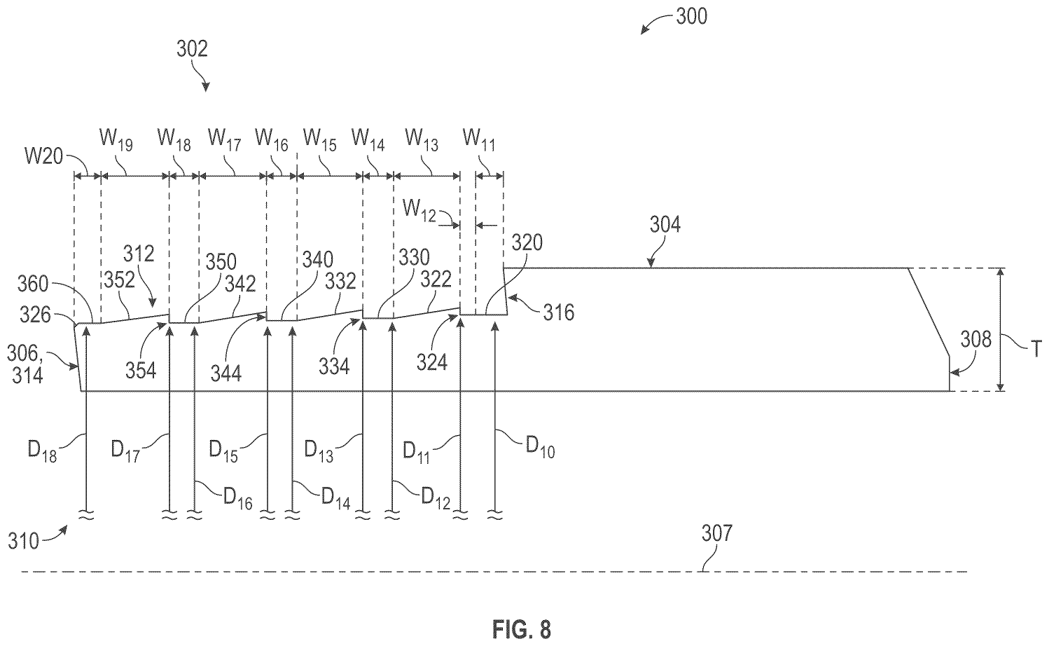

FIG. 8 illustrates the male coupler 300 in greater detail. As noted above with reference to FIG. 3, the male coupler 300 can comprise a plurality of coupling features generally indicated at 302 that are formed in an outer wall surface 304 of the coupler. The male coupler 300 can be a ring configured for attachment to the end of a main length of pipe such as the pipes 102 and 104, or the coupling features 302 can be machined directly into the main pipe as described above. The male coupler 300 can have a first end 306 (also referred to as a distal end) and a second end 308 (also referred to as a proximal end). In the illustrated configuration the male coupler is a ring, and the second end 308 can be configured for attachment to the main length of pipe (e.g., by welding). Once attached to the pipe, the distal end 306 can define a pipe opening 310.

The coupling features 302 can comprise a variety of teeth and/or ridges, sloped and/or ramped surfaces, and/or annular surfaces having a constant or substantially constant diameter similar to the coupling features of the female coupler. The male coupling features 302 can be formed in a distal end portion 312 of the male coupler. At the distal end 306 the male coupler can comprise an end surface 314 (also referred to as a distal end surface) extending radially relative to the longitudinal pipe axis 307. Offset inwardly from the distal end 306 (to the right in FIG. 8) the male coupler can comprise a radially-extending surface referred to hereinafter as a “shelf” or a “proximal shelf” 316. From the shelf 316 onward in the proximal direction (e.g., toward the second end 308) the male coupler can have a thickness T corresponding the nominal thickness of the pipe to which the male coupler is attached. From the shelf 316 moving in a distal direction the male coupler can have a reduced thickness in the area where the coupling features are machined into the outer wall surface 304.

Starting from the shelf 316 and moving in a direction toward the distal end surface 314 (e.g., in a direction toward the pipe opening), the coupler features of the male coupler can comprise a plurality of annular surfaces 320, 330, 340, 350, and 360, having a constant or substantially constant diameter. The coupler features can also include a plurality of ramp surfaces 322, 332, 342, 352, which can be sloped in the direction of the pipe opening. The slopes can be such that the diameters of the ramp surfaces decrease from right to left in FIG. 8 (e.g., in a direction toward the pipe opening).

The coupler features can also include a plurality of teeth generally indicated at 324, 334, 344, and 354. Each tooth can comprise a radially-extending surface that is perpendicular or substantially perpendicular (e.g., 80° to) 110° to the pipe axis, and an apex. As with the female coupler above, the apices of the teeth can mark the transition from the radially-extending surface of the tooth to the adjacent ramp surface.

Thus, the male coupler can comprise, in a direction from the shelf 316 toward the distal end surface 314, a first annular surface 320, a first tooth 324, a first ramp surface 322, a second annular surface 330, a second tooth 334, a second ramp surface 332, a third annular surface 340, a third tooth 344, a third ramp surface 342, a fourth annular surface 350, a fourth tooth 354, a fourth ramp surface 352, and a fifth annular surface 360. In the illustrated example, the fifth annular surface 360 can be an introductory annular surface that engages the annular surface 270 to guide the male and female couplers together when the couplers are engaged. In the illustrated example, the fifth annular surface 360 can be axially aligned with the first annular surface 220 of the female coupler when the male and female couplers are fully engaged. In the illustrated example, a chamfer 326 can extend between the fifth annular surface 360 and the distal end surface 314 to facilitate insertion of the male coupler into the female coupler.

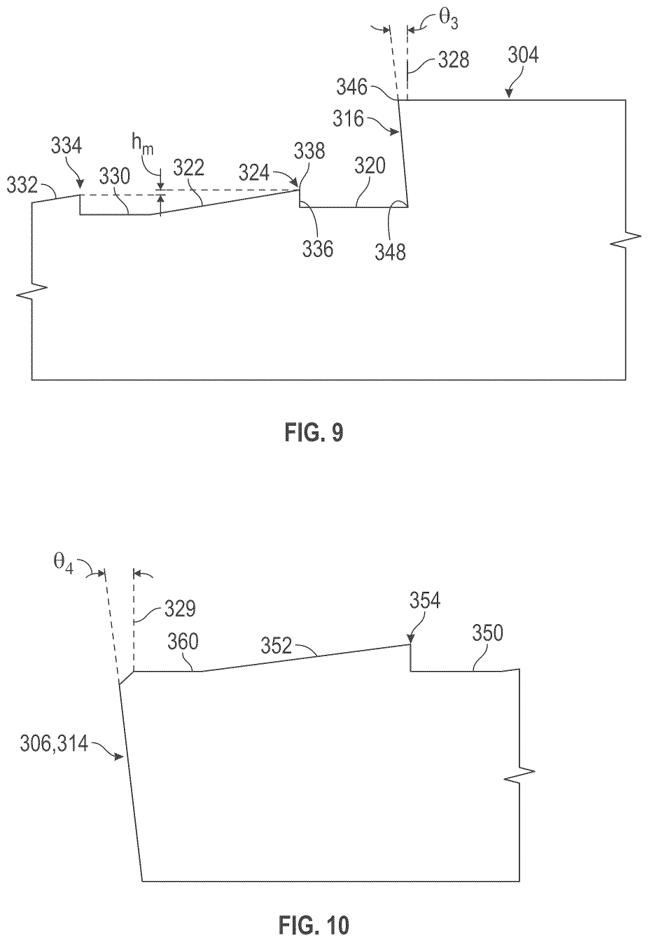

As noted above, each tooth of the male coupler can comprise a radially-extending surface and an apex. FIG. 9 illustrates the first tooth 324 by way of example. The first tooth 324 can include a radially-extending surface 336 that is perpendicular or substantially perpendicular to the pipe axis 307, and an apex 338. The apex 338 can mark the transition between the radially-extending surface 336 and the first ramp surface 322. In the illustrated example, the first tooth 324 does not include an annular surface between the apex 338 and the second ramp surface 332, similar to the female coupler described above.

In certain examples, the distal end surface 314 and/or the shelf 316 can be angled relative to the pipe axis 307. In certain examples, the distal end surface 314 and/or the shelf 316 can be non-perpendicular with the pipe axis 307. In certain examples, one or both of the distal end surface 314 and the shelf 316 can be angled relative to a radially-extending reference line that is perpendicular to the pipe axis 307. For example, FIG. 9 illustrates the shelf 316 in greater detail. The radially-extending surface of the shelf 316 can define an angle θ₃ with a radially-extending reference line 328 that is perpendicular to the pipe axis. In certain examples, the angle θ₃ can be 1° to 45°, such as 1° to 30°, 1° to 20°, 1° to 10°, 2° to 45°, 2° to 30°, 2° to 20°, 2° to 10°, 5° to 45°, 5° to 30°, 5° to 20°, 5° to 15°, 5° to 10°, etc. In one particular example, the angle θ₃ can be 8°. In certain examples, the shelf 316 can be angled such that an apex 346 formed by the intersection of the radially-extending surface of the shelf 316 and the outer wall surface 304 of the coupler is closer to the first tooth 324 than a corner 348 formed by the intersection of the first annular surface 320 and the radially-extending surface of the shelf 316. Stated differently, the apex 346 is closer to the pipe opening than the corner 348.

FIG. 10 illustrates the distal end surface 314 in greater detail. The radially-extending distal end surface 314 can define an angle θ₄ with a radially-extending reference line 329 that is perpendicular to the pipe axis 307. In certain examples, the angle θ₄ can be 1° to 45°, such as 1° to 30°, 1° to 20°, 1° to 10°, 2° to 45°, 2° to 30°, 2° to 20°, 2° to 10°, 5° to 45°, 5° to 30°, 5° to 20°, 5° to 15°, 5° to 10°, etc. In one particular example, the angle θ₄ can be 10°.

In certain examples, the angle θ₄ can be greater than the angle θ₃ or vice versa. In certain examples, the angles θ₃ and 04 can be equal. In certain examples, the angle θ₂ of the distal end surface 214 of the female coupler can be greater than the angle θ₃ of the shelf 316 of the male coupler, or vice versa. For example, in certain examples the angle θ₃ of the shelf 316 of the male coupler can be 50% to 100%, 60% to 100%, 70% to 100%, 80% to 100%, 90% to 100%, 50% to 95%, 60% to 95%, 70% to 95%, 50% to 90%, 60% to 90%, 70% to 90%, etc., of the angle θ₂ of the female coupler distal end surface 214. In the particular example illustrated herein, the angle θ₃ of the male coupler shelf 316 is 80% of the angle θ₂ of the female coupler distal end surface 214. By making the angle θ₃ of the male coupler shelf 316 different from the angle θ₂ of the female coupler distal end surface 214, the male coupler shelf 316 can come into contact with the female coupler distal end surface 214 when the pipes are angulated as further described below.

In certain examples, the annular surfaces, ramps, and teeth of the male coupler features can be arranged in repeating units along the outer wall surface. For example, referring again to FIG. 8, in the illustrated example the region of each tooth 324, 334, 344, and 354 can comprise a repeating unit of, in a direction toward the distal end 306, a radially-extending tooth surface, a ramp surface, and an annular surface. One such repeating unit is illustrated in detail in FIG. 9. The repeating unit can comprise the radially-extending tooth surface 336 of the tooth 324, the ramp surface 322, and the annular surface 330. Moving in a direction toward the pipe opening, the annular surface 330 can lead directly to the next repeating unit, which is a second repeating unit comprising the radially-extending tooth surface of the tooth 334, the ramp surface 332, and the annular surface 340. In the illustrated example, the male coupler can comprise a third repeating unit including the radially-extending tooth surface 344, the ramp 342, and the annular surface 350, and a fourth repeating unit including the radially-extending tooth surface 354, the ramp surface 352, and the annular surface 360. The illustrated male coupler can thus comprise four repeating units of coupler features as defined above in which each annular surface (except for annular surface 360) leads directly to the next radially-extending tooth surface, and each radially-extending tooth surface leads directly to the next ramp surface. Stated differently, the radially-extending surface of each tooth transitions immediately to the following ramp surface at the apex of the tooth without an annular surface between the radially-extending surface and the ramp surface. It should be understood that the male couplers described herein can have any number of repeating units of coupling features according to, for example, the specifications of a particular pipe system to be constructed.

Referring again to FIG. 8, the various coupler features can have widths measured along the pipe axis. For example, the first annular surface 320 can have a total width that is a sum of a width W₁₁ and a width W₁₂. The first ramp 322 can have a width W₁₃, the second annular surface 330 can have a width W₁₄, the second ramp surface 332 can have a width W₁₅, the third annular surface 340 can have a width W₁₆, the third ramp surface 342 can have a width W₁₇, the fourth annular surface 350 can have a width W₁₈, the fourth ramp surface 352 can have a width W₁₉, and the fifth annular surface 360 can have a width W₂₀.

In certain examples, at least the widths W₁₂, W₁₄, W₁₆, and W₁₈ of the first, second, third, and fourth annular surfaces 320, 330, 340, and 350 can be equal or substantially equal (e.g., within ±10% of the specified dimension). In certain examples, the total combined width W₁₁+W₁₂ of the annular surface 320 can be greater than the widths W₁₄, W₁₆, W₁₈, and W₂₀ (e.g., to facilitate receiving the corresponding annular surface 270 at the distal end of the female coupler). For example, the width W₁₁ represents the distance occupied by the annular surface 270 of the female coupler when the male and female couplers are joined together, and the width W₁₂ represents the axial distance along which the male and female couplers may move or slide relative to each other when the pipes are angulated. The width W₂₀ of the annular surface 360 can also be greater than the widths W₁₂, W₁₄, W₁₆, and W₁₈. In certain examples, the total combined width W₁₁+W₁₂ of the annular surface 320 can be greater than the width W₂₀ of the annular surface 360.

In certain examples, the widths W₁₃, W₁₅, W₁₇, and W₁₉ of the first, second, third, and fourth ramp surfaces 322, 332, 342, and 352 can be equal or substantially equal (e.g., within ±10% of the specified dimension). In certain examples, certain of the ramp surfaces can also be longer or shorter than the other ramp surfaces depending on the particular characteristics sought. In certain examples, the ramp surfaces can have the same slope. In other examples, certain of the ramps can have a different slope than other ramps. For example, in certain examples the ramp surface 352 can have a slope that is less than the slopes of the ramp surfaces 342, 332, and/or 322 to facilitate insertion of the male coupler 300 into the female coupler 200 as described with reference to U.S. Pat. No. 10,823,320 incorporated by reference above.

Certain of the coupler features can also have diameters/radii measured perpendicular to the pipe axis 307. For example, the first annular surface 320 can have a diameter D₁₀, the first tooth 324 can have a diameter D₁₁ (e.g., measured between two diametrically opposed locations on the apex of the first tooth 324), the second annular surface 330 can have a diameter D₁₂, the second tooth 334 can have a diameter D₁₃, the third annular surface 340 can have a diameter D₁₄, the third tooth 344 can have a diameter D₁₅, the fourth annular surface 350 can have a diameter D₁₆, the fourth tooth 354 can have a diameter D₁₇, and the fifth annular surface 360 can have a diameter D₁₈. Moving in a direction from the shelf 316 toward the distal end 306, the diameter of the first ramp surface 322 can decrease from the diameter D₁₁ to the diameter D₁₂. The diameter of the second ramp surface 332 can decrease from the diameter D₁₃ to the diameter D₁₄. The diameter of the third ramp surface 342 can decrease from the diameter D₁₅ to the diameter D₁₆, and the diameter of the fourth ramp surface 352 can decrease from the diameter D₁₇ to the diameter D₁₈.

Thus, in certain examples the male coupler can comprise coupler features including, from the shelf 316 in a direction toward the distal end 306, the first annular surface 320 having the diameter D₁₀ (the first annular surface diameter) that is constant moving in the direction toward the distal end, the first tooth 324 comprising the first tooth surface 336 extending radially from the first annular surface 320 away from the pipe axis, the first ramp surface 322 with a diameter (a first ramp surface diameter) that decreases in the direction toward the distal end, the second annular surface 330 having the diameter D₁₂ (the second annular surface diameter) that is constant moving in the direction toward the distal end, and the second tooth 334 including a second tooth surface extending radially from the second annular surface 330. In this example, the first tooth 324 does not have a flat annular surface extending from its apex 338 but instead transitions immediately to the ramp surface 322. This facilitates angulation of the male coupler relative to the female coupler as further explained below.

In certain examples, the diameter of the teeth of the female coupler can increase by a specified height increment moving in a direction toward the pipe opening. For example, referring again to FIG. 7 a female tooth height increase increment h_{f} is shown measured between the tooth 244 and the tooth 254 in the radial direction. Stated differently, the tooth height increase h_{f} from the tooth 244 to the tooth 254 can be expressed by the difference D₉−D₇=h_{f}. In certain examples, the height difference between each sequential tooth of the female coupler can be equal or substantially equal to the height increase increment h_{f}. Similarly, the teeth of the male coupler can have a tooth height decrease increment that is the difference between the diameter of a given tooth and the diameter of the subsequent tooth in a direction toward the pipe opening of the male coupler. Referring to FIG. 9 by way of example, male tooth height decrease increment hₘ is shown measured between the apex of the first tooth 324 and the apex of the subsequent tooth 334, expressed as D₁₁−D₁₃=hₘ. In certain examples, the height difference between each sequential tooth of the male coupler can be equal or substantially equal to the tooth height decrease increment hₘ.

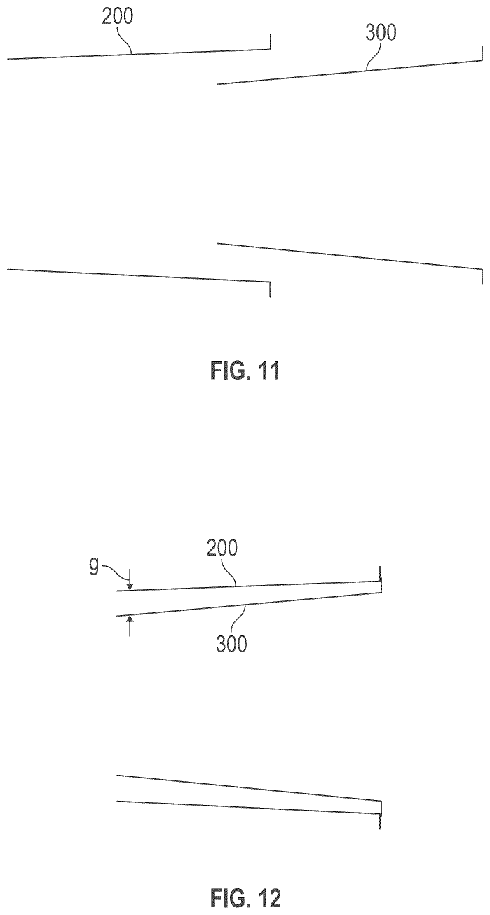

In certain examples, the height increase increment h_{f} of the teeth of the female coupler can be different than the height decrease increment hₘ of the teeth of the male coupler. In certain examples, the height decrease increment hₘ of the male coupler teeth is greater than the height increase increment h_{f} of the female coupler teeth. Thus, the apices of the male coupler teeth step down in the distal direction (e.g., a direction from the shelf 316 toward the distal end surface 314) at a higher rate than the teeth of the female coupler step up in the distal direction (e.g., the direction from the shelf 216 toward the distal end surface 214). FIGS. 11 and 12 schematically illustrate the female and male couplers as cones. The tapered lines of the cones are straight lines connecting the apices of the teeth in a cross-sectional view of the male and female couplers. Stated differently, the tapered lines of the cones are best fit lines connecting the apices of the teeth at locations 180° apart around the circumference of the male and female couplers. As shown in FIG. 11, the cone of the male coupler 300 is more tapered (e.g., narrows at a higher rate from right to left) than the cone of the female coupler 200. The greater slope of the male cone results because the tooth height decrease increment hₘ of the male coupler teeth is greater than the tooth height increase increment h_{f} of the female coupler teeth (e.g., hₘ>h_{f}).

In FIG. 11 the cones of the male coupler 200 and the female coupler 300 only partially overlap, representing initial, partial engagement between the male and female couplers. FIG. 12 illustrates the cones of the male coupler 300 and the female coupler 200 fully engaged, and with the pipe axes aligned (e.g., the male and female couplers are not angulated). As shown in FIG. 12, there can be a relatively larger gap measured in the radial direction between the male coupler and the female coupler at the proximal end of the female coupler (e.g., adjacent the shelf 216) than at the distal end of the female coupler adjacent the end surface 214. The gap between the male and female coupler features increases moving from the pipe opening of the female coupler toward the back (e.g., toward the proximal end) of the female coupler. The gap g defined between the male and female coupler features at the distal end of the male coupler when they are fully engaged can determine the range of angulation of the two couplers, and thus of the two pipes at the joint. The male and female couplers can thus permit a selected degree of angulation of the two pipes that is related to the gap g. In certain examples, the gap g can be measured between the annular surface 360 of the male coupler and the annular surface 220 of the female coupler when the couplers are fully engaged and axially aligned, and with the longitudinal pipe axes parallel to each other. In certain examples, the gap g can be calculated as the difference D₁−D₁₈=g. The gap between the annular surfaces of the male and female couplers can increase moving in a direction from the pipe opening of the female coupler toward the shelf 216.

In certain examples, the gap g defined between the annular surface 360 of the male coupler and the annular surface 220 of the female coupler can be 50% to 150% of the radial height dimension of the tooth surfaces of the female coupler (e.g., the radial distance that the teeth extend above the adjacent annular surface), such as 60% to 110%, 60% to 100%, 70% to 110%, 70% to 100%, etc., of the radial height dimension of the tooth surfaces of the female coupler. The gap g can fall within similar ranges relative to the radial height dimension of the tooth surfaces of the male coupler.

As noted above, the gap g between the male and female couplers can determine the extent of angulation between the couplers when joined together. This is illustrated in FIG. 4. Referring to FIG. 4, when the male and female pipe couplers 300 and 200 are fully engaged and angulated, the joint 100 forms a curve. The coupling features of the proximal end of the male coupler and the coupling features of the distal end of the female coupler can be in contact and/or most closely spaced at the vertex on the inside of the curve formed by the two pipes (e.g., at the top of the cross-section in FIG. 4). The coupling features of the proximal end of the male coupler and the coupling features of the distal end of the female coupler can be spaced apart by a greater amount at the vertex on the outside of the curve (e.g., at the bottom of the cross-section in FIG. 4). In particular examples, the vertex on the inside of the curve can correspond to a distal end surface-shelf contact region 116 in which the distal end surface 214 of the female coupler and the shelf 316 of the male coupler are in contact. Conversely, the coupling features can be spaced apart by the greatest amount, but still engaged, on the opposite side of the curve, for example at the vertex on the outside of the curve. The vertex on the outside of the curve can be circumferentially offset from the distal end surface-shelf contact region 116 by 180° around the circumference of the couplers. When the couplers are angulated to the maximum extent, there may be little if any contact between the distal end surface 214 of the female coupler and the shelf 316 of the male coupler at the vertex on the outside of the curve.

In other examples, the dimension h_{f} of the teeth of the female coupler can be greater than the dimension hₘ of the teeth of the male coupler.

In certain examples, the radial dimension (also referred to as the radial height) of the tooth surfaces of the female coupler can be greater than the radial height of the tooth surfaces of the male coupler. For example, in certain examples the radial dimensions of the tooth surfaces of the female coupler can be 101% to 130% of the radial dimensions of the tooth surfaces of the male coupler, such as 105% to 125%, 105% to 120%, etc. In a particular example, the radial dimensions of the tooth surfaces of the female coupler can be 115% of the radial dimensions of the tooth surfaces of the male coupler.

In certain examples, the angle θ₃ (FIG. 9) of the male coupler shelf 316 and/or the angle θ₄ of the male coupler distal end surface 314 can be larger than the angle formed between the axes of the male and female coupler when they are angulated. For example, in FIG. 4 the axis 207 of the female coupler 200 forms an angle α relative to the axis 307 of the male coupler 300. The male coupler shelf 316 can be sized and shaped such that when the male and female couplers are joined together and angulated as shown in FIGS. 3 and 4, the angle θ₃ of the male coupler shelf 316 can be 1.5α to 12α (e.g., 1.5 times to 12 times the angle α), such as 1.5α to 10α, 1.5α to 8α, 1.5α to 6α, 1.5α to 5α, 1.5α to 4α, 1.5α to 3α, 1.5α to 2α, 2α to 12α, 2α to 10α, 2α to 8α, 2α to 6α, 2α to 5α, 2α to 4α, 2α to 3α, 3α to 10α, 4α to 10α, 5α to 10α, etc. The angle θ₄ of the male coupler distal end surface 314 can have any of the angle ranges given above with reference to θ₃. By angling the male coupler shelf 316 and/or the male coupler distal end surface 314 in this way, the force of the pipe jack on the couplers can drive the couplings together and avoid one coupler slipping over the other.

Any or all of the pipe coupling examples described herein can provide a number of significant advantages over existing pipe couplings. For example, the pipe couplings described herein can provide the ability to angulate or articulate the pipes at a joint relative to each other within a selected range of motion that is surprisingly large, and without compromising the structural integrity of the joint. The vertex and the distal end surface-shelf contact region 116 of the resulting curved joint can be located at any location around the circumference of the pipe couplings. By coupling multiple pipes together using the couplings described herein, a pipe system with a curved path of specified curvature can be constructed between two end points. The angle between pipes achievable with the couplings described herein can vary according to the diameter of the pipes, but can be 2° or more in some examples.

Moreover, the configuration of the male and female pipe couplings described herein can provide significant advantages in the context of tunneling and microtunneling applications where sequential casing pipes are driven into a curved tunnel shaft (for example, by jacking). For example, the angled distal end surfaces and the angled shelf surfaces of the male and female couplings can facilitate contact between these surfaces when the couplings are joined together at an angle as shown in FIG. 4. The angle ranges of these surfaces described herein can ensure that a relatively larger surface area of the distal end surfaces and the shelf surfaces are in contact at the vertex of the curve than if the surfaces were perpendicular to the respective axes of the couplers. Because the force of the pipe jack is transmitted between pipe sections at the area where the pipe couplings are in contact, a greater contact area at the interface between the distal end surface of the female coupler and the shelf of the male coupler in particular can improve force transmission, especially along a pipe system with multiple pipes coupled at multiple angled joints. Angling the distal end surface of the female coupler and the shelf of the male coupler as described herein can also urge the surfaces together in abutting contact. Stated differently, the angled distal end surface of the female coupler and the angled shelf of the male coupler serve to force the joint together as the pipes are jacked forward in the shaft, and can reduce or prevent “ramping” in which the female coupler slides over the outer diameter surface of the male coupler. The angled surfaces of the female coupler shelf 216 and the male coupler distal end surface 314 can also improve contact between these surfaces at the vertex when the pipes are angulated, further contributing to force transmission along the pipe system.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A pipe, comprising: a pipe axis; a first end portion and a second end portion, the second end portion comprising a female coupler, the female coupler comprising an inner wall surface and a set of coupler features formed on the inner wall surface, the coupler features comprising a plurality of teeth and a plurality of ramp surfaces between the teeth, the first end portion of the pipe defining a pipe opening; the second end portion of the pipe comprising a radially-extending distal end surface; the female coupler further comprising a radially-extending shelf formed in the inner wall surface on an opposite side of the coupler features from the distal end surface; wherein the distal end surface and the shelf are angled relative to a radially-extending reference line that is perpendicular to the pipe axis.

Example 2. The pipe of any example herein, particularly example 1, wherein the distal end surface forms an angle with the radially-extending reference line of 2° to 20°.

Example 3. The pipe any example herein, particularly example 1 or example 2, wherein the shelf forms an angle with the radially-extending reference line of 2° to 20°.

Example 4. The pipe of any example herein, particularly examples 1-3, wherein the angle formed by the distal end surface with the radially-extending reference line and the angle formed by the shelf with the radially-extending reference line are different.

Example 5. The pipe of any example herein, particularly examples 1-3, wherein the angle formed by the distal end surface with the radially-extending reference line and the angle formed by the shelf with the radially-extending reference line are equal.

Example 6. The any example herein, particularly examples 1-4, wherein the angle formed by the distal end surface with the radially-extending reference line is greater than the angle formed by the shelf with the radially-extending reference line.

Example 7. The pipe of any example herein, particularly examples 1-4, wherein the angle formed by the distal end surface with the radially-extending reference line is less than the angle formed by the shelf with the radially-extending reference line.

Example 8. The pipe of any example herein, particularly examples 1-7, wherein the coupler features comprise a repeating unit of, in a direction toward the pipe opening, a radially-extending tooth surface and a ramp surface that extends from the tooth surface to an annular surface, wherein a next radially-extending tooth surface extends from the annular surface.

Example 9. The pipe of any example herein, particularly examples 1-8, wherein the coupler features comprise, in a direction from the shelf toward the distal end, a first annular surface having a first annular surface diameter that is constant moving in the direction toward the distal end, a first ramp surface with a first ramp surface diameter that increases in the direction toward the distal end, a second annular surface having a second annular surface diameter that is constant moving in the direction toward the distal end, a first tooth comprising a first tooth surface extending radially from the second annular surface toward the pipe axis, and a second ramp surface extending from the first tooth surface to a third annular surface in the direction toward the distal end.

Example 10. The pipe of any example herein, particularly examples 1-9, wherein the first end portion of the pipe comprises a male coupler comprising a plurality of coupler features formed on an outer wall surface of the male coupler.

Example 11. A pipe system, comprising: the pipe of example 1, wherein the pipe is a first pipe; and a second pipe comprising a male coupler that is coupled to the female coupler of the first pipe, the male coupler comprising: an outer wall surface and a set of male coupler features formed on the outer wall surface, the male coupler features comprising a plurality of ramp surfaces and teeth; the male coupler of the second pipe comprising a radially-extending distal end surface; the male coupler further comprising a radially-extending shelf formed in the outer wall surface on an opposite side of the coupler features from the male coupler distal end surface; wherein the distal end surface and the shelf of the male coupler are angled relative to a radially-extending reference line that is perpendicular to an axis of the second pipe.

Example 12. A pipe, comprising: a pipe axis; a first end portion and a second end portion, the first end portion comprising a male coupler, the male coupler comprising an outer wall surface and a set of coupler features formed on the outer wall surface, the coupler features comprising a plurality of ramp surfaces and teeth, the first end portion of the pipe defining a pipe opening; the first end portion of the pipe comprising a radially-extending distal end surface; the male coupler further comprising a radially-extending shelf formed in the outer wall surface on an opposite side of the coupler features from the distal end surface; wherein the distal end surface and the shelf are angled relative to a radially-extending reference line that is perpendicular to the pipe axis.

Example 13. The pipe of any example herein, particularly example 12, wherein the distal end surface forms an angle with the radially-extending reference line of 5° to 20°.

Example 14. The pipe of any example herein, particularly example 12 or example 13, wherein the shelf forms an angle with the radially-extending reference line of 5° to 20°.

Example 15. The pipe of any example herein, particularly examples 12-14, wherein the angle formed by the distal end surface with the radially-extending reference line and the angle formed by the shelf with the radially-extending reference line are different.

Example 16. The pipe of any example herein, particularly examples 12-14, wherein the angle formed by the distal end surface with the radially-extending reference line and the angle formed by the shelf with the radially-extending reference line are equal.

Example 17. The pipe of any example herein, particularly examples 12-15, wherein the angle formed by the distal end surface with the radially-extending reference line is greater than the angle formed by the shelf with the radially-extending reference line.

Example 18. The pipe of any example herein, particularly examples 12-15, wherein the angle formed by the distal end surface with the radially-extending reference line is less than the angle formed by the shelf with the radially-extending reference line.

Example 19. The pipe of any example herein, particularly examples 12-18, wherein the second end portion of the pipe comprises a female coupler comprising a plurality of coupler features formed on an inner wall surface of the female coupler.

Example 20. A pipe system, comprising: a first pipe, comprising: a first pipe axis; a first end portion and a second end portion, the second end portion comprising a female coupler, the female coupler comprising an inner wall surface and a set of first coupler features formed on the inner wall surface, the first coupler features comprising a plurality of teeth and a plurality of ramp surfaces between the teeth, the first end portion of the first pipe defining a first pipe opening; the second end portion of the first pipe comprising a radially-extending distal end surface; the female coupler further comprising a radially-extending shelf formed in the inner wall surface on an opposite side of the first coupler features from the distal end surface; wherein the distal end surface and the shelf are angled relative to a radially-extending reference line that is perpendicular to the first pipe axis; a second pipe, comprising: a second pipe axis; a first end portion and a second end portion, the first end portion comprising a male coupler, the male coupler comprising an outer wall surface and a set of coupler features formed on the outer wall surface, the coupler features comprising a plurality of ramp surfaces and teeth, the first end portion of the second pipe defining a pipe opening; the first end portion of the second pipe comprising a radially-extending distal end surface; the male coupler further comprising a radially-extending shelf formed in the outer wall surface on an opposite side of the coupler features from the distal end surface; wherein the distal end surface and the shelf of the male coupler are angled relative to a radially-extending reference line that is perpendicular to the second pipe axis; wherein the male coupler of the second pipe is received within the female coupler of the first pipe such that the male coupler features engage the female coupler features to form a pipe joint.

Example 21. The pipe system of any example herein, particularly example 20, wherein the first pipe is angulated relative to the second pipe.

Example 22. The pipe system of any example herein, particularly example 20 or example 21, wherein: the first pipe axis and the second pipe axis define an angle α between them; and an angle defined between the shelf of the male coupler and the radially-extending reference line that is perpendicular to the second pipe axis is 1.5α to 10α.

Example 23. The pipe system of any example herein, particularly examples 20-22, wherein: the first pipe axis and the second pipe axis define an angle α between them; and an angle defined between the distal end surface of the male coupler and the radially-extending reference line that is perpendicular to the second pipe axis is 1.5α to 10α.

Example 24. A pipe, comprising: a first end portion comprising a female coupler, the female coupler comprising an inner wall surface and a set of coupler features formed on the inner wall surface, the first end portion of the pipe defining a pipe opening; the pipe comprising a radially-extending shelf formed in the inner wall surface on an opposite side of the coupler features from the pipe opening; wherein the coupler features comprise a repeating unit of, in a direction toward the pipe opening, a radially-extending tooth surface and a ramp surface that extends from the tooth surface to an annular surface, wherein a next radially-extending tooth surface extends from the annular surface.

Example 25. A pipe, comprising: a pipe axis; a female coupler mounted to or formed in a first end of the pipe, the female coupler comprising an inner wall surface and a set of coupler features formed on the inner wall surface, the coupler features comprising a plurality of ramp surfaces and teeth, the first end of the pipe defining a pipe opening; the first end of the pipe comprising a distal end and a radially-extending shelf formed in the inner wall surface on an opposite side of the coupler features from the distal end; the coupler features comprising, in a direction from the shelf toward the distal end, a first annular surface having a first annular surface diameter that is constant moving in the direction toward the distal end, a first ramp surface with a first ramp surface diameter that increases in the direction toward the distal end, a second annular surface having a second annular surface diameter that is constant moving in the direction toward the distal end, a first tooth comprising a first tooth surface extending radially from the second annular surface toward the pipe axis, and a second ramp surface extending from the first tooth surface to a third annular surface in the direction toward the distal end.

Example 26. A pipe system, comprising: a first pipe comprising a female coupler having a distal end and a radially-extending shelf formed in an inner wall surface of the first pipe, the shelf being spaced apart from the distal end along a longitudinal axis of the first pipe; a second pipe comprising a male coupler received in the female coupler of the first pipe to form a joint; the female coupler of the first pipe comprising a plurality of tooth surfaces extending radially inwardly from annular surfaces formed in the inner wall surface of the first pipe; the male coupler of the second pipe comprising a plurality of radially-extending tooth surfaces formed in an outer wall surface of the second pipe, the tooth surfaces of the second pipe engaging the tooth surfaces of the first pipe, wherein the annular surfaces of the second pipe are axially aligned with annular surfaces of the first pipe, and wherein gaps measured in the radial direction between the annular surfaces of the second pipe and the axially aligned annular surfaces of the first pipe increase moving in a direction from the distal end of the first pipe toward the shelf of the first pipe.

Example 27. A pipe system, comprising: a first pipe comprising a female coupler having a distal end and a radially-extending shelf formed in an inner wall surface of the first pipe, the shelf being spaced apart from the distal end along a longitudinal axis of the first pipe; a second pipe comprising a male coupler received in the female coupler of the first pipe to form a joint; the female coupler of the first pipe comprising a plurality of tooth surfaces extending radially inwardly from annular surfaces formed in the inner wall surface of the first pipe; the male coupler of the second pipe comprising a plurality of radially-extending tooth surfaces formed in an outer wall surface of the second pipe, the tooth surfaces of the second pipe engaging the tooth surfaces of the first pipe, wherein radial heights of the tooth surfaces of the first pipe are greater than radial heights of the tooth surfaces of the second pipe.

Example 28. A pipe system, comprising: a first pipe comprising a female coupler having a distal end and a radially-extending shelf formed in an inner wall surface of the first pipe, the shelf being spaced apart from the distal end along a longitudinal axis of the first pipe; a second pipe comprising a male coupler received in the female coupler of the first pipe to form a joint; the female coupler of the first pipe comprising a plurality of tooth surfaces extending radially inwardly from annular surfaces formed in the inner wall surface of the first pipe; the male coupler of the second pipe comprising a plurality of radially-extending tooth surfaces formed in an outer wall surface of the second pipe, the tooth surfaces of the second pipe engaging the tooth surfaces of the first pipe, wherein the male coupler comprises a first annular surface nearest an opening defined by the second pipe, the female coupler comprises a first annular surface nearest the shelf of the female coupler, and wherein a gap defined between the first annular surface of the male coupler and the first annular surface of the female coupler is 70% to 110% of a radial height of the tooth surfaces of the female coupler.

The features described herein with regard to any example can be combined with other features described in any one or more of the other examples, unless otherwise stated. For example, any one or more of the features of one pipe coupler example can be combined with any one or more features of another pipe coupler example.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims and equivalents of the features recited therein. We therefore claim all that comes within the scope and spirit of these claims.

1. A pipe, comprising:
a pipe axis;
a first end portion and a second end portion, the second end portion comprising a female coupler, the female coupler comprising an inner wall surface and a set of coupler features formed on the inner wall surface, the coupler features comprising a plurality of teeth and a plurality of ramp surfaces between the teeth, the first end portion of the pipe defining a pipe opening;
the second end portion of the pipe comprising a radially-extending distal end surface;
the female coupler further comprising a radially-extending shelf formed in the inner wall surface on an opposite side of the coupler features from the distal end surface;
wherein the distal end surface and the shelf are angled relative to a radially-extending reference line that is perpendicular to the pipe axis.

2. The pipe of claim 1, wherein the distal end surface forms an angle with the radially-extending reference line of 2° to 20°.

3. The pipe of claim 2, wherein the shelf forms an angle with the radially-extending reference line of 2° to 20°.

4. The pipe of claim 3, wherein the angle formed by the distal end surface with the radially-extending reference line and the angle formed by the shelf with the radially-extending reference line are different.

5. The pipe of claim 3, wherein the angle formed by the distal end surface with the radially-extending reference line and the angle formed by the shelf with the radially-extending reference line are equal.

6. The pipe of claim 3, wherein the angle formed by the distal end surface with the radially-extending reference line is greater than the angle formed by the shelf with the radially-extending reference line.

7. The pipe of claim 3, wherein the angle formed by the distal end surface with the radially-extending reference line is less than the angle formed by the shelf with the radially-extending reference line.

8. The pipe of claim 1, wherein the coupler features comprise a repeating unit of, in a direction toward the pipe opening, a radially-extending tooth surface and a ramp surface that extends from the tooth surface to an annular surface, wherein a next radially-extending tooth surface extends from the annular surface.

9. The pipe of claim 1, wherein the coupler features comprise, in a direction from the shelf toward the distal end, a first annular surface having a first annular surface diameter that is constant moving in the direction toward the distal end, a first ramp surface with a first ramp surface diameter that increases in the direction toward the distal end, a second annular surface having a second annular surface diameter that is constant moving in the direction toward the distal end, a first tooth comprising a first tooth surface extending radially from the second annular surface toward the pipe axis, and a second ramp surface extending from the first tooth surface to a third annular surface in the direction toward the distal end.

10. The pipe of claim 1, wherein the first end portion of the pipe comprises a male coupler comprising a plurality of coupler features formed on an outer wall surface of the male coupler.

11. A pipe system, comprising:
the pipe of claim 1, wherein the pipe is a first pipe; and
a second pipe comprising a male coupler that is coupled to the female coupler of the first pipe, the male coupler comprising:
an outer wall surface and a set of male coupler features formed on the outer wall surface, the male coupler features comprising a plurality of ramp surfaces and teeth;
the male coupler of the second pipe comprising a radially-extending distal end surface;
the male coupler further comprising a radially-extending shelf formed in the outer wall surface on an opposite side of the coupler features from the male coupler distal end surface;
wherein the distal end surface and the shelf of the male coupler are angled relative to a radially-extending reference line that is perpendicular to an axis of the second pipe.

12. A pipe, comprising:
a pipe axis;
a first end portion and a second end portion, the first end portion comprising a male coupler, the male coupler comprising an outer wall surface and a set of coupler features formed on the outer wall surface, the coupler features comprising a plurality of ramp surfaces and teeth, the first end portion of the pipe defining a pipe opening;
the first end portion of the pipe comprising a radially-extending distal end surface;
the male coupler further comprising a radially-extending shelf formed in the outer wall surface on an opposite side of the coupler features from the distal end surface;
wherein the distal end surface and the shelf are angled relative to a radially-extending reference line that is perpendicular to the pipe axis.

13. The pipe of claim 12, wherein the distal end surface forms an angle with the radially-extending reference line of 5° to 20°.

14. The pipe of claim 13, wherein the shelf forms an angle with the radially-extending reference line of 5° to 20°.

15. The pipe of claim 14, wherein the angle formed by the distal end surface with the radially-extending reference line and the angle formed by the shelf with the radially-extending reference line are different.

16. The pipe of claim 14, wherein the angle formed by the distal end surface with the radially-extending reference line and the angle formed by the shelf with the radially-extending reference line are equal.

17. The pipe of claim 14, wherein the angle formed by the distal end surface with the radially-extending reference line is greater than the angle formed by the shelf with the radially-extending reference line.

18. The pipe of claim 14, wherein the angle formed by the distal end surface with the radially-extending reference line is less than the angle formed by the shelf with the radially-extending reference line.

19. The pipe of claim 12, wherein the second end portion of the pipe comprises a female coupler comprising a plurality of coupler features formed on an inner wall surface of the female coupler.

20. A pipe system, comprising:
a first pipe, comprising:
a first pipe axis;
a first end portion and a second end portion, the second end portion comprising a female coupler, the female coupler comprising an inner wall surface and a set of first coupler features formed on the inner wall surface, the first coupler features comprising a plurality of teeth and a plurality of ramp surfaces between the teeth, the first end portion of the first pipe defining a first pipe opening;
the second end portion of the first pipe comprising a radially-extending distal end surface;
the female coupler further comprising a radially-extending shelf formed in the inner wall surface on an opposite side of the first coupler features from the distal end surface;
wherein the distal end surface and the shelf are angled relative to a radially-extending reference line that is perpendicular to the first pipe axis;
a second pipe, comprising:
a second pipe axis;
a first end portion and a second end portion, the first end portion comprising a male coupler, the male coupler comprising an outer wall surface and a set of coupler features formed on the outer wall surface, the coupler features comprising a plurality of ramp surfaces and teeth, the first end portion of the second pipe defining a pipe opening;
the first end portion of the second pipe comprising a radially-extending distal end surface;
the male coupler further comprising a radially-extending shelf formed in the outer wall surface on an opposite side of the coupler features from the distal end surface;
wherein the distal end surface and the shelf of the male coupler are angled relative to a radially-extending reference line that is perpendicular to the second pipe axis;
wherein the male coupler of the second pipe is received within the female coupler of the first pipe such that the male coupler features engage the female coupler features to form a pipe joint.

21. The pipe system of claim 20, wherein the first pipe is angulated relative to the second pipe.

22. The pipe system of claim 21, wherein:
the first pipe axis and the second pipe axis define an angle α between them; and
an angle defined between the shelf of the male coupler and the radially-extending reference line that is perpendicular to the second pipe axis is 1.5α to 10α.

23. The pipe system of claim 21, wherein:
the first pipe axis and the second pipe axis define an angle α between them; and
an angle defined between the distal end surface of the male coupler and the radially-extending reference line that is perpendicular to the second pipe axis is 1.5α to 10α.
